(19) United States
(12) Patent Application Publication
(10) Pub. No.: US 2025/0391066 A1
(43) Pub. Date: Dec. 25, 2025

(54) On-treatment joint CT-MR imaging from sparse measurements

(71) Applicant: The Board of Trustees of the Leland Stanford Junior University, Stanford, CA (US)

(72) Inventors: Oscar Pastor-Serrano, Palo Alto, CA (US); Lei Xing, Palo Alto, CA (US)

(21) Appl. No.: 19/243,252

(22) Filed: Jun. 19, 2025

Related U.S. Application Data
(60) Provisional application No. 63/661,652, filed on Jun. 19, 2024.

(51) Int. Cl. G06T 11/00; G06N 3/04

(52) U.S. Cl. CPC G06T 11/003; G06N 3/04

(57) ABSTRACT

A method for medical imaging includes performing a single-modality scan of a subject using a single-modality imaging device to acquire sparse measurements, wherein the single-modality is either computed tomography (CT) or magnetic resonance imaging (MRI); and simultaneously reconstructing both CT and MR image pairs from the sparse single-modality measurements using a multi-layer perceptron (MLP) neural network; wherein initial weights of the MLP are learned from a pair of pre-treatment CT and MR images of the subject.

### CROSS-REFERENCE TO RELATED APPLICATIONS

This application claims priority from U.S. Provisional Patent Application 63/661,652 filed Jun. 19, 2024, which is incorporated herein by reference.

### STATEMENT OF FEDERALLY SPONSORED RESEARCH

This invention was made with Government support under contract CA256890 awarded by the National Institutes of Health. The Government has certain rights in the invention.

### FIELD OF THE INVENTION

The present invention relates generally to techniques for medical imaging. More specifically, it relates to methods for joint CT-MR image generation from sparse CT or MRI measurements.

### BACKGROUND OF THE INVENTION

Computed Tomography (CT) and Magnetic Resonance (MR) imaging play a critical role in clinical workflows, particularly in patient diagnosis, treatment simulation, and monitoring. CT imaging is highly valued for its rapid provision of patient geometry and electron densities critical for calculating physical radiation doses. On the other hand, in many clinical situations, MR imaging is preferred for its superior soft tissue contrast and lower radiation exposure, though it faces challenges like longer reconstruction times and the need for dense sampling. Using both CT and MR imaging in clinical workflows is thus highly desirable to leverage their respective advantages. However, the sequential acquisition of CT and MR images is lengthy and impractical from the clinical workflow perspectives. The approach can also lead to errors due to the anatomical changes during the time gap between scans, complicating the treatment process with extended durations and the need for precise image registration.

The success of image-guided interventions (IGI) critically depends on our ability to target the diseased volume while adequately sparing normal anatomy during treatment, often involving the use of computed tomography (CT) and magnetic resonance (MR) images for disease localization or treatment guidance. Multi-modal acquisition of CT/MR pairs offers the benefits of both modalities, i.e., the soft-tissue contrast necessary for accurate segmentation from MR and the differentiation in high-contrast regions from CT.

Currently, multi-modality imaging is performed prior to patient treatment for disease diagnosis and treatment planning, where the acquisition of the CT and MR is performed independently and is formulated as an inverse problem aimed at reconstructing the final images from independently measured sensor data. Obtaining low-noise CT/MR image pairs necessitates dense sampling in measurement space from two machines with different imaging physics, posing challenges for both image modalities, e.g., increasing the radiation dose delivered by CT projections and the MR reconstruction times. Additionally, while ideally employed in tandem to leverage their respective strengths and weaknesses, pairing CT and MR images presents its own set of challenges. Firstly, both image modalities must be independently acquired within the shortest time possible to minimize anatomical changes, thereby increasing the total treatment time. Secondly, the registration of both images to the same coordinate system introduces additional uncertainties. Together, these steps result in prohibitively long acquisition times. Given the time constraints for therapeutic guidance, a comprehensive strategy to efficiently integrate multi-modal information for treatment has yet to be fully developed.

### SUMMARY OF THE INVENTION

Here we disclose a method that can simultaneously reconstruct both CT and MR images efficiently by solely using measurements from only one of the two modalities and with only one pair of pre-treatment CT and MRI images of the patient. This approach provides a framework for on-treatment, simultaneous generation of CT and MR images using solely sparse measurements from either the CT or MR imaging device. This approach mitigates the limitations associated with the sequential use of CT and MR imaging in clinical settings, specifically the challenges of increased radiation exposure from CT and the lengthy reconstruction times of MR images. This approach also addresses the difficulty of accurately and efficiently combining CT and MR images due to anatomical changes over time and the complexity involved in registering the images to the same coordinate system. This approach overcomes challenges that currently hinder the effectiveness and efficiency of patient diagnosis, treatment simulation, positioning, and monitoring in various medical applications, notably radiation therapy.

Significantly, this method, called Adaptive Neural Representation (ANR), has the ability to simultaneously reconstruct CT and MR image pairs from either complete or sparse measurement data acquired from a single machine (either MR or CT), leveraging a generalizable neural representation algorithm. This approach significantly streamlines clinical workflows by offering the combined benefits of both imaging modalities-enhanced soft tissue contrast from MR and precise electron density maps from CT without the tradeoffs of conventional registration approach in image domain. A key feature is the incorporation of an anatomy-adaptive layer within a multi-layer perceptron (MLP) neural network, which, initialized by embedding artificial deformations of a prior CT-MR image pair, rapidly adjusts to new anatomical data from a minimal number of machine measurements from a single machine (either MR or CT). This patient-specific model overcomes the previous barriers of data diversity and generalization, reducing reliance on large-scale datasets and speeding up the process of image acquisition and all downstream application tasks, all while minimizing additional patient irradiation.

The present approach introduces several key improvements and advantages over existing imaging techniques:

1. Reduced radiation exposure: By enabling the reconstruction of CT images from ultra-sparse X-ray projection data (in the case where sparse CT data is used rather than sparse MR data), ANR significantly decreases the radiation dose required for imaging. This contrasts with traditional CT imaging, which can expose patients to higher levels of radiation, especially in scenarios requiring repeated scans.

2. Enhanced speed of image acquisition: The ability to quickly reconstruct accurate images from minimal measurements drastically reduces the time from image acquisition to diagnostic interpretation. This is a stark improvement over the current workflow, where the acquisition and processing of MR and CT images are performed sequentially, often extending the overall treatment planning and delivery timeline.

3. Improved image quality with sparse data: The model's innovative use of neural networks and an anatomy-adaptive layer for the reconstruction process enables high-quality imaging outcomes even from limited input data. This capacity to maintain image quality with sparse measurements is a considerable leap forward, particularly in comparison to conventional methods that may require dense sampling to achieve similar quality levels.

4. Cost efficiency: By consolidating the imaging process into a single, efficient workflow that utilizes sparse data, the ANR model has the potential to reduce the operational costs associated with medical imaging. This includes savings from reduced imaging time, lower radiation source usage, and minimized need for repeat scans.

5. Patient-specific nature: The model's design to incorporate prior patient scans ensures that imaging is closely tailored to individual anatomical variations while reducing the dependency on large datasets that are often difficult to obtain. Furthermore, unlike population-based deep learning methods, ANR is not required to generalize across disease sites, treatment machines, machine parameters settings and pre-processing techniques.

Commercial Applications include the following:

1. Oncology and Radiation Therapy: In cancer treatments, precise imaging is crucial for tumor delineation and radiation therapy planning. This method could be coupled to a conventional CT machine to aid radiation therapy treatment planning or assist with diagnostics and monitoring disease progression, potentially leading to more effective and targeted therapies with fewer side effects.

2. Image-guided radiation oncology: The algorithm can be coupled to existing image-guided radiation therapy machines, enabling near real-time adaptation of treatments.

3. Image guided surgery or other interventions: Providing detailed information of bony structures, soft tissue and structural anomalies, the method could assist during surgical procedures by providing patient anatomies in real-time, such as stent placements, bypass surgeries, and treatment for myocardial infarction.

4. Preventive medicine and screening: This technology could be used in screening programs to detect early signs of disease, such as cancer or cardiovascular disease, with lower radiation doses than current methods.

In one aspect, the invention provides a method for medical imaging, the method comprising: a) performing a single-modality scan of a subject using a single-modality imaging device to acquire sparse measurements, wherein the single-modality is either computed tomography (CT) or magnetic resonance imaging (MRI); and b) simultaneously reconstructing using the single-modality imaging device both CT and MR image pairs from the sparse single-modality measurements using a multi-layer perceptron (MLP) neural network; wherein initial weights of the MLP are learned from a pair of pre-treatment CT and MR images of the subject.

Preferably, the MLP accepts pixel spatial coordinates as input and outputs deformation vectors that transform the pre-treatment CT and MR images to the reconstructed CT and MR image pairs.

Preferably, simultaneously reconstructing the CT and MR image pairs comprises 1) updating weights of only an anatomy-adaptive layer of the MLP using the sparse single-modality measurements, 2) generating deformation vectors using the MLP, and 3) transforming the pre-treatment CT and MR images to the reconstructed CT and MR image pairs using the deformation vectors. The anatomy-adaptive layer preferably encodes information specific to an individual patient anatomy and can be updated to represent other patient anatomies. Updating weights of an anatomy-adaptive layer of the MLP preferably comprises back-propagating a gradient of a loss through a forward Radon transform.

### BRIEF DESCRIPTION OF THE DRAWINGS

FIG. 1A is a schematic diagram illustrating an Adaptive Neural Representation (ANR) architecture used for prior embedding, according to an embodiment of the invention.

FIG. 1B is a schematic diagram illustrating an Adaptive Neural Representation (ANR) architecture used for anatomy reconstruction, according to an embodiment of the invention.

FIG. 2 is a graph of reconstruction accuracy vs. anatomy-adaptive layer position, according to an embodiment of the invention.

FIG. 3A is a graph of peak signal-to-noise ratio vs. number of prior images, according to an embodiment of the invention.

FIG. 3B is a graph of structure similarity metric vs. number of prior images, according to an embodiment of the invention.

FIG. 3C is a graph of peak signal-to-noise ratio vs. number of prior images, according to an embodiment of the invention.

FIG. 3D is a graph of structure similarity metric vs. number of prior images, according to an embodiment of the invention.

FIG. 4 is an image grid showing Brain CT and MR reconstructions, according to an embodiment of the invention.

FIG. 5 is an image grid showing on-treatment reconstruction accuracy vs. reconstruction time, according to an embodiment of the invention.

FIG. 6A is a graph of on-treatment reconstruction peak signal-to-noise ratio vs. reconstruction time for pelvic CT, according to an embodiment of the invention.

FIG. 6B is a graph of on-treatment reconstruction peak signal-to-noise ratio vs. reconstruction time for pelvic MR, according to an embodiment of the invention.

FIG. 6C is a graph of on-treatment reconstruction peak signal-to-noise ratio vs. reconstruction time for brain CT, according to an embodiment of the invention.

FIG. 6D is a graph of on-treatment reconstruction peak signal-to-noise ratio vs. reconstruction time for brain MR, according to an embodiment of the invention.

### DETAILED DESCRIPTION OF THE INVENTION

We disclose here an adaptive neural representation (ANR) for joint CT-MR image generation from sparse measurements from only a single imaging modality scan (i.e., either CT or MRI). Unlike existing NR-based image reconstruction methods, where pre-treatment images are embedded into network weights, our approach introduces a neural representation with an anatomy-adaptive layer to capture the diverse deformation fields between pre- and on-treatment images. This anatomy-adaptive layer accommodates all potential anatomical changes in on-treatment images by embedding them into the layer's weights during model training. To reconstruct CT and MR images using on-treatment single-modality measurements, the ANR model adjusts the anatomy-adaptive layer's weights to achieve the best match between estimated and measured single-modality measurements. The resulting deformation field is then used to generate corresponding on-treatment CT and MR images. Extensive validations are conducted to demonstrate the performance of the ANR-based CT-MRI imaging scheme. In one example, with just 20 X-ray projections, ANR achieves a peak signal-to-noise ratio (PSNR) three times higher than conventional methods like filtered back projection. Additionally, ANR generates accurate MR images with a PSNR twice as high as that achieved by conventional CT-MRI registration. The joint reconstruction process is computationally efficient, completing in under three minutes on a single GPU.

Using neural representation methods, we disclose herein an on-treatment multi-modality CT-MR imaging framework, which utilizes sparse on-treatment single-modality measurements and seamlessly integrates prior knowledge, significantly facilitating patient setup, disease target localization, and the clinical decision-making process.

This adaptive neural representation (ANR) algorithm is capable of jointly reconstructing CT/MR image pairs from ultra-sparse X-ray projection data, or from ultra-sparse MRI data. Being a patient-specific approach, the ANR model embeds a diverse set of potential anatomical features into the weights of a multi-layer perceptron (MLP) neural network with an anatomy-adaptive layer which captures traits specific to each anatomical deformation. This design eliminates the need for extensive training or large-scale datasets, requiring only a single prior image pair and simulated plausible deformations. For example, with only a few newly acquired X-ray projections, this anatomy-adaptive layer can be quickly adjusted to accurately represent the new deformation between the prior CT and the new on-treatment anatomy. The resulting deformation field is then used to obtain the corresponding on-treatment MR images.

In the following description, we focus primarily on the case of training the ANR model and using it to reconstruct CT and MR images from sparse X-ray data. The methods apply also to the case of reconstructing CT and MR images from sparse MRI data.

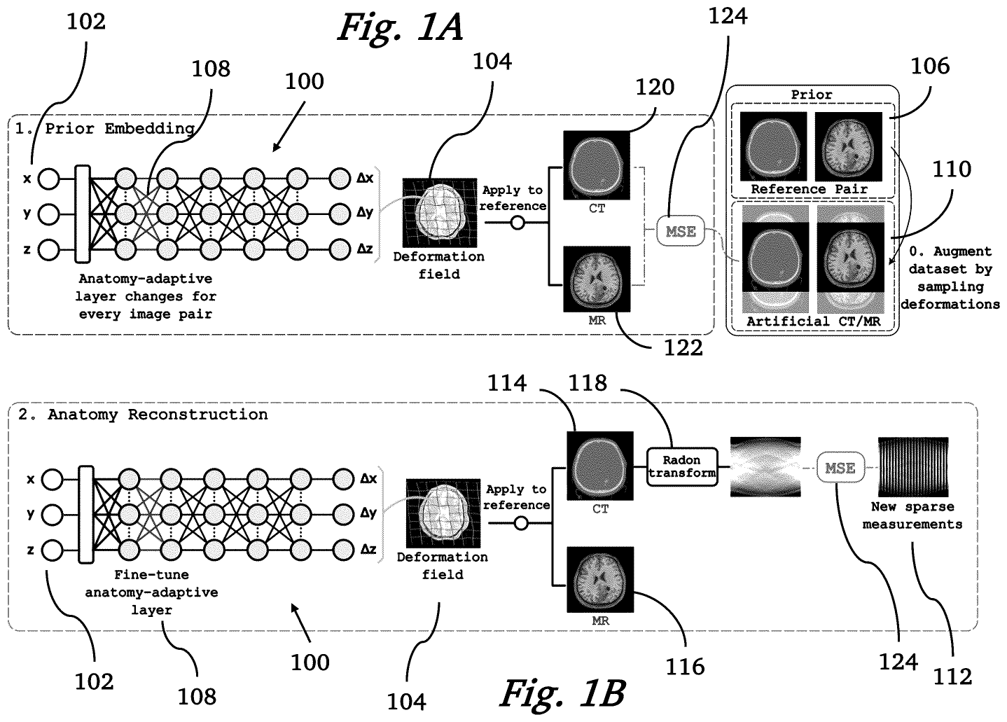

FIG. 1A and FIG. 1B illustrate a framework for a method of joint MRI-CT image generation, according to an embodiment of the invention, called Adaptive Neural Representation (ANR). Essentially, the framework simplifies image registration into a rapid, X-ray projection-driven search for the optimal MLP parameters characterizing the new deformation of the reference anatomy.

A multi-layer perceptron (MLP) 100 takes spatial coordinates 102 as input and predicts the deformation vectors 104 between a reference CT-MR pair 106 and the on-treatment anatomies 120, 122. The predicted deformation vector 104 quantifies how to warp the corresponding voxel in the reference images 106 to match the on-treatment anatomy.

The second layer 108 of the MLP, referred to as the anatomy-adaptive layer, captures instance-specific variations and is specific to each pair 106, while the remaining weights of the MLP are consistent across patient samples and process low frequency features resulting from the anatomy modulation.

First, we embed a few simulated deformations 110 into the network's weights. The weights of the anatomy-adaptive layer 108 represent traits specific to each anatomical deformation, thereby capturing instance-specific variations. The remainder of the weights are shared across all on-treatment anatomies and contain generic features about the deformations.

When new X-ray projection measurements 112 are recorded, we use that data to adjust only the weights of the anatomy-adaptive layer 108 to correct the deformation vectors and then obtain updated CT image 114 and MR image 116. This adjustment process involves back-propagating the gradient of the mean squared error (MSE) loss through the forward Radon transform 118. The MSE block 124 is used to produce a measure of dissimilarity between image or measurement pairs. It computes the average squared error between two samples, and it is used to find the set of MLP/anatomy-adaptive layer weights that minimize this metric.

### Problem Formulation

We frame the reconstruction problem as starting from a forward process y=Ax+e, where x∈R^{M} is the CT image of the unknown subject with M voxels, y∈R^{N}^{ₚ}^{×D} are a finite number Nₚ of sampled projections, A represents the forward model (i.e., the Radon transform), and e is acquisition noise. The corresponding inverse process aims at recovering x from sparse y measurements, and is generally formulated as an optimization problem with regularization as

$${min}_{x} E ( A x , y ) + ρ ( x ) , \qquad ( 1 )$$

with an error term E(Ax, y) such as the L2 norm, and a regularization term ρ(x) characterizing image prior information. Using a limited amount of measurements y to reduce time or radiation dose, sparse image reconstruction is done by finding the correct source image x, which is typically an ill-posed problem.

Instead of finding the new image x directly, our approach finds the deformation ϕ∈R^{M×3} warping a reference CT xₚ into x, so that ϕ(c) denotes the displacement applied to the voxel centered at location c∈[0,1)³, and ϕ∘xₚ denotes the application of the deformation field to warp the reference image. The optimization problem then becomes

$${min}_{ϕ} E ( A [ ϕ ∘ {x}_{p} ] , y ) + ρ ( ϕ ∘ {x}_{p} ) . \qquad ( 2 )$$

B. Generalizable Neural Representation with Anatomy-Adapted Layer

Adapting an implicit neural representation approach, we use a MLP M_{θ,η} with parameters θ and η to represent deformations between a prior reference image and subsequent on-treatment anatomies, where the MLP maps spatial coordinates c to the corresponding 3D deformation vector as

$${M}_{θ , η} : c \to ϕ ( c ) with ϕ ∈ {R}^{3} . \qquad ( 3 )$$

The MLP includes an anatomy-adaptive layer with parameter θ that is specific to the deformation between the prior and each subsequent anatomy and embeds sample-specific variations. Placing the anatomy-adaptive layer right after the first layer will result in θ learning specific low-frequency features that will be further transformed by the remaining shared parameters η in the MLP. Thus, we want to find the optimal parameters to characterize the transformation between both the reference CT xₚ and its paired MR zₚ and the image pair x and z from the new anatomy. To do this, we first embed prior information into the MLP, and then fine-tune the initial weights to obtain the new deformation from sparse measurements.

### Embedding Prior Information

For a given subject, we can embed a small set {ϕₙ}^{N}ₙ₌₁ of prior deformations within the weights of the MLP, characterizing a registration between the reference CT/MR scans and N on-treatment pairs {xₙ, zₙ}^{N}ₙ₌₁, all from the same patient. For this purpose, we digitally deform the given pre-treatment CT/MR images of an imaging subject in at least 10 characteristic ways, and embed the deformation fields within the MLP. Embedding this prior data into ANR is done by obtaining a set of optimum weights {η*, {θₙ}^{N}ₙ₌₁} via an iterative optimization problem:
1) For each pair {xₙ, zₙ}^{N}ₙ₌₁, keeping n fixed:

$${min}_{{θ}_{n}} {‖ {M}_{{θ}_{n} , {η}^{*}} ∘ {x}_{p} - {x}_{n} ‖}^{2} + {‖ {M}_{{θ}_{n} , {η}^{*}} ∘ {z}_{p} - {z}_{n} ‖}^{2} . \qquad ( 4 )$$

2) For all {xₙ, zₙ, θₙ}^{N}ₙ₌₁, freezing all θₙ weights:

$${min}_{η} {‖ {M}_{{θ}_{n}^{*} , η} ∘ {x}_{p} - {x}_{n} ‖}^{2} + {‖ {M}_{{θ}_{n}^{*} , {η}^{∘}} {z}_{p} - {z}_{n} ‖}^{2} . \qquad ( 5 )$$

We refer to Eq. (4) and Eq. (5) as the inner and outer loops, respectively, where the inner loop individually finds the optimum anatomy-adaptive weights for each pair, and the outer loop finds the optimal shared weights over all prior deformations.

### Reconstructing New Anatomies

Starting from the trained weights (η* and one of the θₙ), and once new projections are obtained, we can effectively formulate the search in image space as an optimization over the θ weight space. Among the multiple sets of anatomy-adaptive layer weights, we start from the one that the one that results in higher similarity in projection space, further fine-tuning them as

$${min}_{{θ}_{r}} E ( A [ {M}_{{θ}_{n} , {η}^{*}} ∘ {x}_{p} ] , y ) \qquad ( 6 )$$

aiming at obtaining the shared weights θᵣ for the new geometry. Since the Radon transform A is differentiable, the gradients can be back-propagated to obtain the new neural representation minimizing the error term. Note that we disregard the explicit regularization term p, since all prior information is contained in the starting network's weights.

### Dataset

We obtained 20 CT/MR pairs from brain and pelvic patients undergoing radiation therapy from the publicly available dataset of the SynthRad challenge. All brain and pelvic MR images correspond to a spoiled T1 weighted gradient echo sequences and were recorded with a Philips Ingenia® machine, with a field strength of 1.5 T. The CT scans were obtained from a Philips Brilliance Big Bore® machine with 120 kVp.

All pairs were rigidly aligned and anonymized via defacing both images. We further pre-processed all CT scans, re-scaling all Hounsfield Unit (HU) values to the interval [0,1], using the maximum and minimum of each image. Likewise, after performing a bias field correction, all MR images are standardized by subtracting the mean and dividing by the standard deviation. All volumes are cropped to a cube of size 200×200×32 and a voxel resolution of 1 mm.

### Technical Details

a) Fourier feature encoding: Fourier features have been proved to help training implicit neural representation, helping to learn high-frequency functions that are useful for the first layers of the MLP. Following the same approach, we transform the input coordinates c using a Fourier feature mapping into a vector y, which is then passed to the neural representation. The Fourier features are obtained as

$$γ ( c ) = concat [ cos ( 2 π Bc ) , sin ( 2 π Bc ) ] , \qquad ( 7 )$$

with the matrix B representing the coefficients of the Fourier feature transformation, with entries sampled from a Gaussian distribution N(0,σ²). The standard deviation of the prior distribution σ is a hyper-parameter.

b) Diffeomorphic deformations: Deep learning registration architectures have been adapted to produce diffeomorphic deformation fields, which have the advantage of being invertible and (generally) smoother. Our implicit neural representation architecture also outputs diffeomorphic transformations as a stationary velocity vectors u∈R³ that are integrated into a diffeomorphic field over seven steps with an integration layer performing scaling and squaring.

c) Prior embedding: In our implementation, we construct a MLP with 6 layers, 256 neurons per layer, and a periodic activation function, where the weights of the second (anatomy-adaptive) layer vary for each image pair. Based on previous works, we use a Fourier feature mapping of size 512 that encodes the input coordinates before the first layer and helps the network learn high-frequency functions, with a standard deviation of σ=4. The MLPs are implemented in PyTorch. For prior embedding, we generate 10 artificial image pairs by applying randomly sampled deformations to each pair in the dataset. The deformations were sampled using a 9×9×9 cubic B-spline grid, where (i) a 3D displacement vector of maximum 3 cm is sampled for each grid control point, and (ii) deformations are interpolated between control points to obtain the final global deformation. In practice, we find that the random displacements significant enough to induce notable differences, often larger than those between recorded scans.

For each patient, we train the MLP weights iteratively for 1000 iterations using the Adam optimizer, with a starting learning rate of 1e⁻⁴ that is halved each time the loss plateaus for 20 epochs. For each of the 10 anatomy pairs in the augmented patient-specific dataset, one loop in both the inner and outer optimization uses eight forward and backward passes of all the coordinate points available.

d) Image reconstruction: Once the prior MLP weights are obtained, we fine-tune the anatomy-specific layer for each test image pair over 2000 iterations. In this case, since the minimization problem is limited to (6), each iteration is a single forward and backward pass of all the coordinate points. We use the Adam optimizer with a fixed learning rate of 1e⁻⁵ and default momentum parameters.

To showcase the capabilities of the ANR method, we conducted experiments aimed at reconstructing CTs and their corresponding MR intensities from ten brain and ten pelvic cancer patients. We evaluated the algorithm's performance in reconstructing image pairs from only 20 projections. In our analysis, we included results from CT and MR image reconstructions achieved using various baseline methods for comparison. For each patient, we initialized the weights by embedding ten artificial image pairs. Subsequently, leveraging this prior information, we reconstructed new CT/MR image pairs from sparse measurements. To gauge the accuracy of the reconstructions, we computed several metrics assessing reconstruction fidelity.

### Baselines

We compared the reconstruction performance of ANR to that of the methods that would be used in the clinics to reconstruct MR from sparse X-ray measurements. The following baselines were used to reconstruct CT and MRs on the same data:
For CT reconstruction, we employed the analytical Filtered Back-Projection (FBP) algorithm as the primary baseline, hereinafter referred to as “FBP” in this section. Despite advancements in iterative reconstruction algorithms, FBP remains widely utilized in clinical settings primarily due to its speed. As such, FBP obtains the intensity values for the reconstructed image directly from the available X-ray projection measurements.
Based on the FBP results, we conducted an image registration step to acquire the deformation field between the prior and FBP-reconstructed image, utilizing the open-source software elastix. The deformation obtained was then applied to the reference CT, resulting in the second baseline denoted as “SparseW”. For MR reconstruction, to our knowledge, there are no existing methods to generate images from X-ray measurements. Therefore, we also warped the reference MR utilizing the deformation field obtained from the image registration between the FBP-reconstructed image and the reference CT. In the remainder of the paper, we refer to SparseW_{CT} and SparseW_{MR} to distinguish when the method is applied to CT or MR, respectively.
Additionally, we introduce a third baseline termed “FullW” which involves applying the deformation field obtained from the registration between the ground-truth on-treatment CT and the reference CT images. This method uses densely sampled measurement data and assumes that there is no CT reconstruction error, thus having an advantage with respect to the other baselines. We use FullW_{CT} and FullW_{MR} to denote the application of the resulting deformation field to warp reference CT or MR images, respectively.
Finally, we include a ANR model that directly deforms the images without any prior embedding step, denoted ANR₀.

For all these, we assessed the accuracy in reconstructing images via the peak signal-to-noise ratio (PSNR) and the structure similarity metric (SSIM). PSNR measures the quality of an image by quantifying the ratio between the maximum possible power of a signal and the power of corrupting noise that affects the fidelity of the representation. The range of possible values for PSNR is typically between 0 and infinity and depends on the image modality, with higher values indicating better reconstruction quality. Alternatively, SSIM evaluates the similarity between two images based on luminance, contrast, and structural information, providing a more holistic assessment of reconstruction quality. While SSIM can range between −1 and 1, typical values are positive and range from 0 to 1, with higher values indicating greater similarity between images.

### Ablation Studies

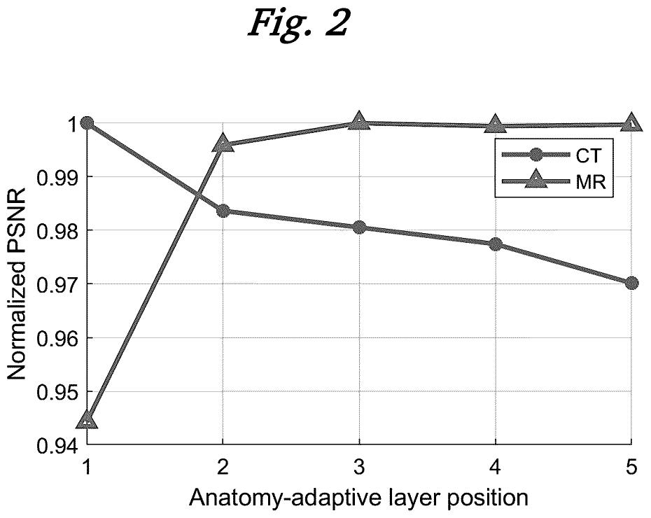

To fine-tune our model architecture, we conducted a series of ablation studies focusing on two main aspects: the optimal positioning of the anatomy-adaptive layer within the model and the ideal number of prior deformations to be embedded for enhanced reconstruction accuracy. FIG. 2 is a graph of CT and MR reconstruction accuracy vs. anatomy-adaptive layer position. For different models where only the position of the anatomy-adaptive layer is changed, we show the average PSNR between the reconstructed and ground-truth CT and MR images, normalized to the interval [0,1] by dividing by the maximum observed value for each modality. Except for the position of the layer, all the models are identical, including training data, settings and hyper-parameters.

Our investigations, depicted in FIG. 2, reveal the impact of the anatomy-adaptive layer's placement on CT and MR reconstruction accuracy. Based on these insights, we positioned the anatomy-adaptive layer as the second layer within the ANR framework, since this strategic placement is preferred over the initial layer to prevent overfitting to the CT modality. This decision also aligns with prior neural representation studies, which indicate that the first layers tend to capture low-frequency features. Thus, inserting and modulating the anatomy-adaptive in the second position may encourage the model to learn key anatomy-specific features that can be transformed into high-frequency patterns in downstream layers.

Furthermore, our analysis extends to evaluating the effect of varying the number of prior deformations on the model's performance.

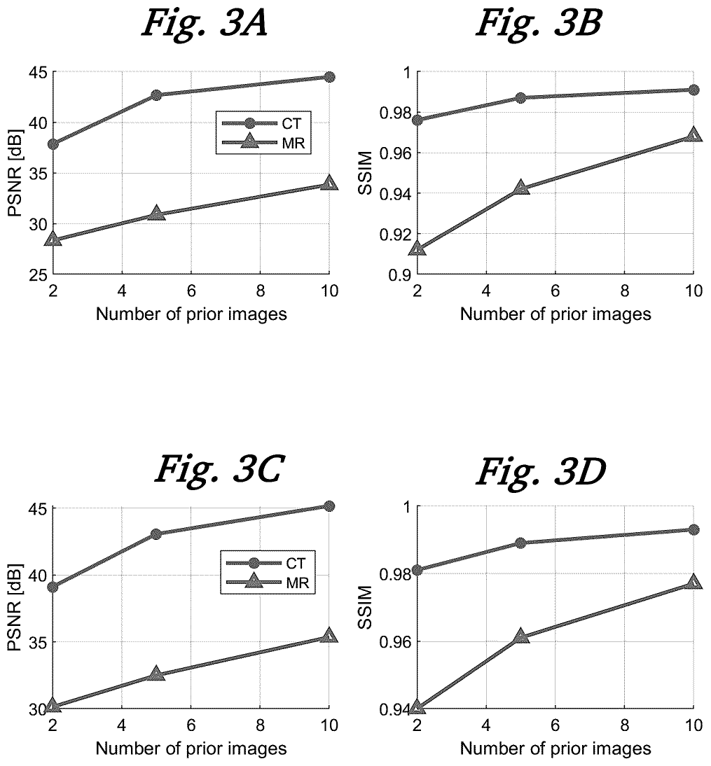

FIGS. 3A, 3B, 3C, 3D are graphs of accuracy vs. number of prior embedding deformations. Test set reconstruction accuracy metrics (PSNR and SSIM) obtained after fine-tuning the anatomy-adaptive layer, from a ANR model that has been initialized through a prior embedding step with 2, 5 or 10 artificial deformations. The results displayed correspond to (FIG. 3A, 3B) one of the patients among the brain cancer cohort, and (FIG. 3C, 3D) one random patient from the pelvic cancer group. One line shows CT reconstruction performance, while the other line denotes MR accuracy metric values.

As illustrated in FIG. 3A, 3B. FIG. 3C, 3D, this comparative study consistently demonstrates that incorporating 10 prior deformations significantly increases both PSNR and SSIM metrics across the board, with a pronounced impact on MR image reconstructions. This outcome highlights the critical role of prior deformations in achieving optimal reconstruction accuracy, thus informing our decision to embed 10 prior deformations in the ANR model.

### Reconstruction Accuracy

Based on the ablation study, we proceeded to evaluate ANR's reconstruction accuracy using 10 prior embedding deformations and 20 X-ray measurements. For each of the 20 patients, we calculate the PSNR and SSIM between the ground truth on-treatment anatomy and the images reconstructed by the model. For the brain anatomies, Table I presents a comparison between the PSNR and SSIM of the reconstructed images and those of baseline methods. We included results for a ANR model initialized with 10 prior deformations (ANR₁₀) and a variant without any prior embedding (ANR₀). Demonstrating a superior PSNR and SSIM for CT scan reconstruction, ANR significantly surpassed the FBP baseline, achieving results that were three times better on the same test images. Moreover, with the exception of the FullW_{CT} baseline, ANR exhibited markedly higher accuracy than other methods for both CT and MR image reconstructions.

TABLE I shows image reconstruction accuracy metrics. The PSNR and SSIM are shown for all the baselines and the ANR model, with (ANR₁₀) and without (ANR₀) prior embedding. Values indicate the average and standard deviation across brain or pelvic cancer patients. Except for the FullW_{CT} and FullW_{MR} baselines using the dense X-ray measurements, all other reconstructed images are obtained from only 20 X-ray projections.

TABLE I

| | | | |
|---|---|---|---|
| Modality | Method | PSNR [dB] | SSIM |

Brain

| | | | |
|---|---|---|---|
| CT | FBP | 15.51 ± 1.31 | 0.436 ± 0.041 |
| | FullW_{CT} | 39.27 ± 2.14 | 0.995 ± 0.001 |
| | SparseW_{CT} | 25.22 ± 4.37 | 0.897 ± 0.040 |
| | ANR₀ | 35.55 ± 2.29 | 0.977 ± 0.006 |
| | ANR₁₀ | 42.24 ± 2.21 | 0.993 ± 0.001 |
| MR | FullW_{MR} | 29.27 ± 2.14 | 0.909 ± 0.033 |
| | SparseW_{MR} | 19.86 ± 2.14 | 0.655 ± 0.066 |
| | ANR₀ | 23.67 ± 0.76 | 0.759 ± 0.019 |
| | ANR₁₀ | 33.02 ± 0.84 | 0.964 ± 0.006 |

Pelvic

| | | | |
|---|---|---|---|
| CT | FBP | 18.22 ± 0.48 | 0.449 ± 0.020 |
| | FullW_{CT} | 41.61 ± 1.06 | 0.986 ± 0.004 |
| | SparseW_{CT} | 31.17 ± 2.60 | 0.906 ± 0.031 |
| | ANR₀ | 45.12 ± 0.61 | 0.990 ± 0.001 |
| | ANR₁₀ | 44.82 ± 0.49 | 0.991 ± 0.001 |
| MR | FullW_{MR} | 34.55 ± 1.74 | 0.976 ± 0.009 |
| | SparseW_{MR} | 23.39 ± 1.22 | 0.865 ± 0.023 |
| | ANR₀ | 30.21 ± 1.10 | 0.943 ± 0.006 |
| | ANR₁₀ | 34.75 ± 1.52 | 0.975 ± 0.006 |

The effectiveness of embedding prior deformations is highlighted by two key observations: firstly, ANR achieves comparable results to FullW_{CT} in CT reconstruction and significantly outperforms FullW_{MR} in reconstructing MRs. This indicates that incorporating prior information crucially aids in refining the deformation field, especially with limited projections from the less informative CT domain. Secondly, while ANR₀ and ANR₁₀ exhibit similar accuracy in CT reconstruction, the absence of a prior embedding step notably reduces ANR₀'s performance in MR image reconstruction. These findings underscore the value of prior embeddings in enhancing model adaptability and accuracy across different imaging modalities.

ANR's superiority extends beyond brain anatomy to include pelvic cancer reconstructions, underscoring its versatility across different anatomical regions. The data in Table I also highlight this by detailing the PSNR and SSIM for the 10 pelvic cancer patients, where ANR continues to outperform other baseline methods. Nonetheless, the difference between ANR10, ANR0, and the FullW_{CT} baseline is less pronounced in pelvic cases compared to brain scenarios. This may be attributed to the pelvic region's more heterogeneous HU values, which aids the registration process and lessens the reliance on prior embeddings.

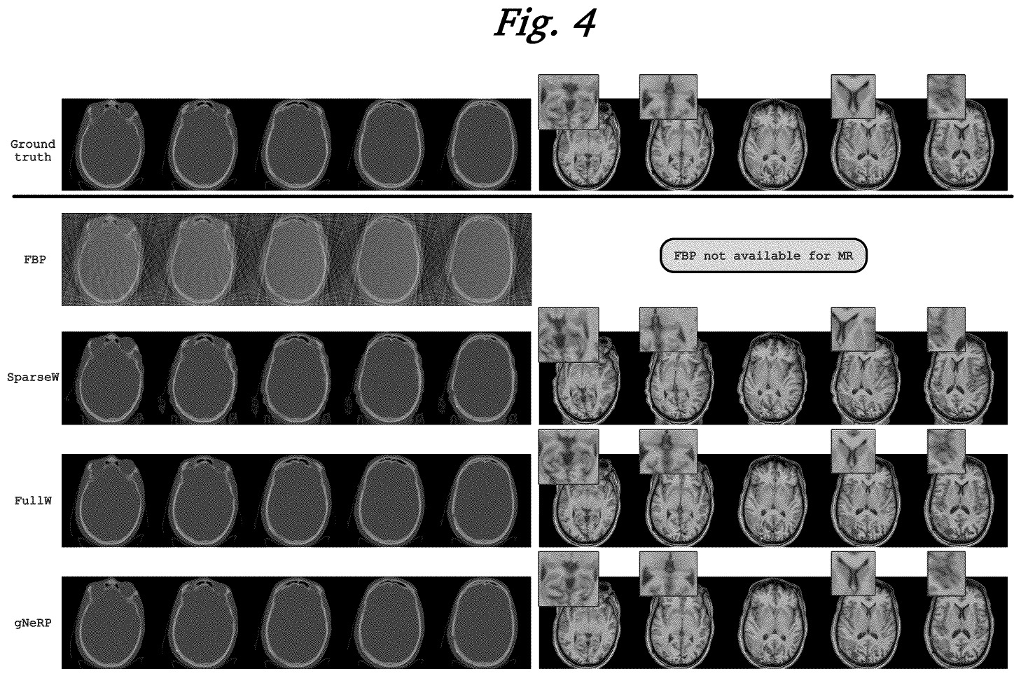

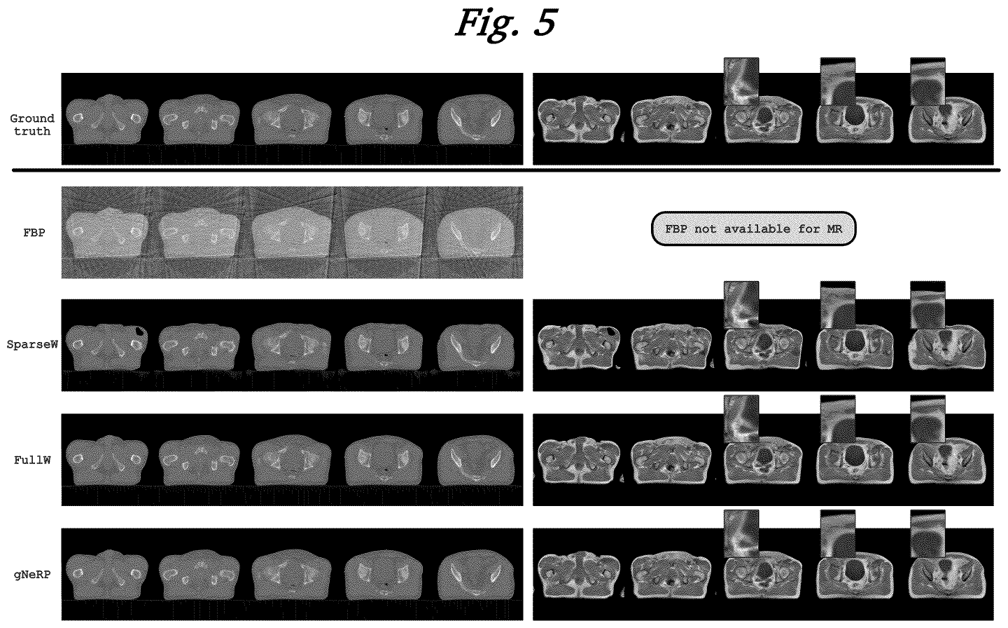

Adding to the quantitative analysis, FIG. 4 and FIG. 5 provide a visual comparison of ANR's reconstructed CT and MR images against those produced by baseline methods, for a randomly selected brain and pelvic cancer patient, respectively. The figures are structured to first display the ground-truth on-treatment anatomies in the top row, followed by various baseline reconstructions in subsequent rows, and concluding with ANR's results in the bottom row. Notably, ANR's reconstructions exhibit almost identical features to the ground-truth, highlighting the model's precision.

In the brain CT and MR reconstructions of FIG. 4, multiple axial slices from the 3D images are shown, corresponding to each of the baselines and the ANR model. The left column shows CT scans, while the right column displays MR images including a zoomed region to facilitate visual comparison.

On-treatment reconstruction accuracy vs. reconstruction time is shown in FIG. 5. For each of the baselines and the ANR model with (ANR₁₀) or without (ANR₀) prior embedding, we display both the CT and MR reconstruction accuracy (y-axis) and the time needed to reconstruct images on-treatment (x-axis). Points closer the top left corner represent methods with the best accuracy and reconstruction speed. All image pairs are reconstructed using 20 X-ray projections.

The second row, depicting the FBP method, illustrates the challenges of reconstructing CT from sparse measurements, resulting in noisy images. These noisy reconstructions contribute to erroneous deformation fields, which, as depicted in the third row with the SparseW baseline, lead to artifacts and unrealistic geometric displacements in both CT and MR images. Although the FullW baseline, presented in the fourth row above ANR's results, produces images that closely resemble the ground truth, it falls short in accurately aligning MR tissues with the reference on-treatment MR images. This visual evidence further solidifies ANR's superior performance in generating accurate and reliable reconstructions across different patient anatomies and imaging modalities.

### Prediction Times

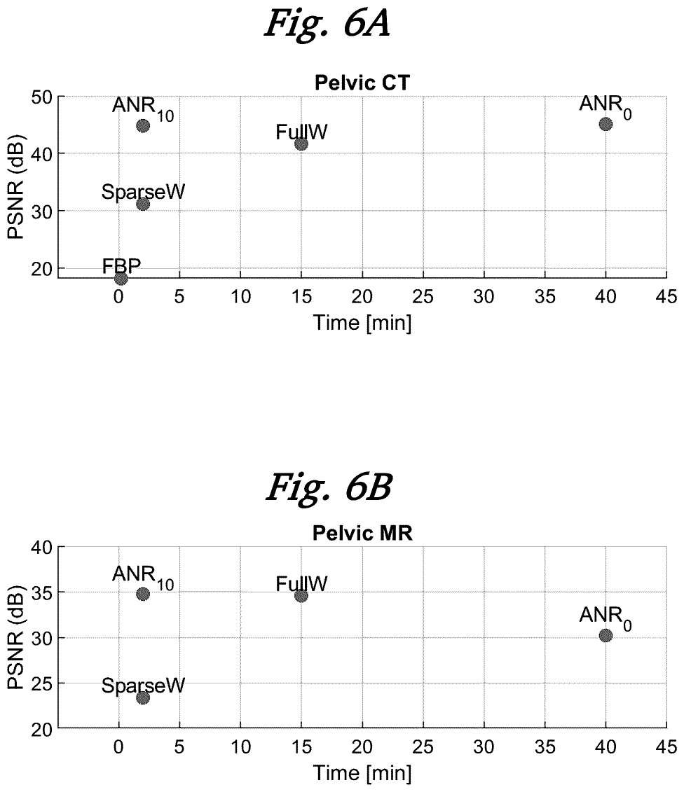

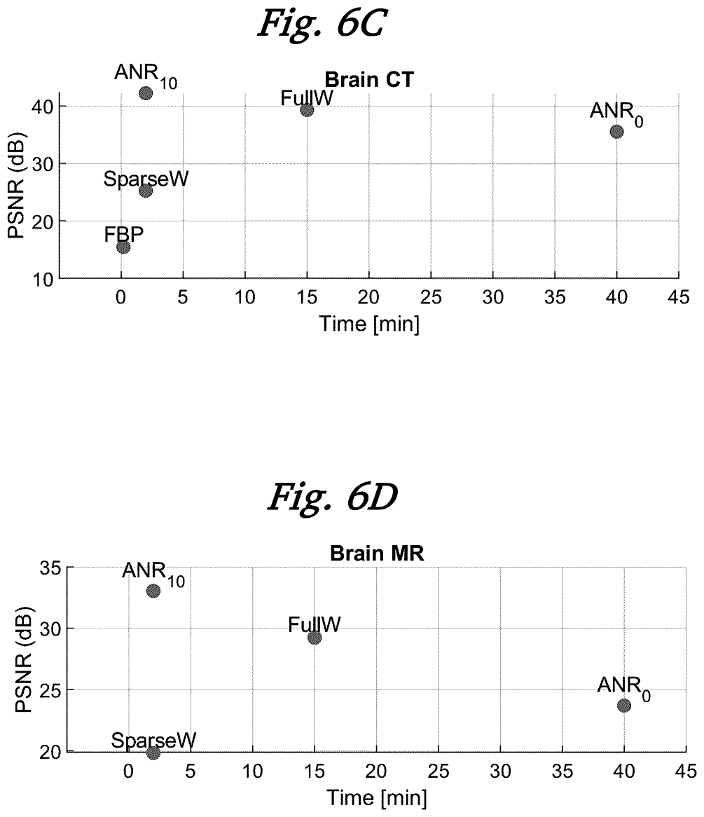

Alongside accurately reconstructing images, reconstruction speed is a highly desirable trait, profoundly impacting patient care, and clinical workflow optimization. For this reason, we also compared the reconstruction accuracy and speed of ANR to the baselines. FIG. 6A, FIG. 6B, FIG. 6C, FIG. 6D show the PSNR (y-axis) and corresponding reconstruction speed (x-axis) for each of the approaches. Models close to the top-left corner are better, since they offer faster reconstruction times with greater accuracy. Overall, being able to reconstruct images in only two minutes and outperforming other methods, ANR offers the best accuracy-speed ratio.

On-treatment reconstruction accuracy vs. reconstruction time are shown in FIG. 6A, FIG. 6B, FIG. 6C, FIG. 6D. For each of the baselines and the ANR model with (ANR₁₀) or without (ANR₀) prior embedding, both the CT and MR reconstruction accuracy and time are show. Points closer the top left corner represent methods with the best accuracy and reconstruction speed. All image pairs were reconstructed using 20 X-ray projections. The left column depicts pelvic CT and MR metrics, while the right column shows the results for brain image reconstruction.

The ANR algorithm for reconstructing CT and MR images from sparse X-ray projection data can potentially allow and enhance IGI by simultaneously providing paired CT/MR images, offering superior soft tissue contrast without requiring dense sampling or both CT and MR acquisition machinery. Throughout our experiments, ANR consistently outperformed all patient-specific baselines, which were carefully selected as the most practical alternatives for acquiring CT and MR pairs solely from X-ray measurements in current clinical settings. Notably, ANR achieves unparalleled accuracy, surpassing or matching the performance of traditional registration algorithms that rely on a perfectly reconstructed CT (represented by the FullW baselines), but with a fraction of the X-ray measurements and reducing radiation exposure by a factor of 50. Additionally, ANR stands out for its speed, largely due to the innovative approach of initializing the majority of the network's weights during the prior embedding phase, which remain unaltered during CT/MR reconstruction. In the configuration we employed, only a minimal set of parameters (256×256) requires adjustment for every new anatomy. This aspect highlights ANR's potential for rapid processing, making it a highly promising tool for enhancing diagnostic imaging and treatment planning in clinical practice.

The patient-specific nature of our methodology also confers distinct advantages in terms of reconstruction performance. Recent advancements in deep learning have predominantly focused on training models to establish mappings between various image modalities, relying on extensive datasets and substantial computational resources. These population-based deep learning methods must contend with the challenge of generalizing to unseen samples beyond the training distribution, especially when confronted with variations in machinery settings across diverse clinical environments. In contrast, ANR is patient-specific and obviates both problems. Thus, ANR deliberately overfits prior information derived solely from a single subject, effectively capturing patient-specific details often eluded by other models, while reducing generalization demands.

During the prior embedding step, ANR can be trained to map input coordinates to deformations with minimal data samples in just a few hours using a single graphics processing unit. For every new patient, only one CT and MR reference pair is required, which must be reconstructed from densely-sampled measurements. During on-treatment reconstruction, ANR quickly adjusts a small fraction of its weights to provide the new image pair in only a couple of minutes.

Among the many possible downstream clinical applications, the fast image reconstruction capabilities of ANR render it well-suited for any image-guided treatment, especially those demanding short processing times. Notably, the method proves instrumental in image-guided radiation therapy treatments that necessitate the rapid acquisition of CT/MR pairs, concurrently facilitating contour delineation and physical dose distribution reconstruction. Furthermore, future research endeavors could be directed towards extending the applicability of ANR to reconstruct paired images directly from MR sensor data, as well as extending the framework to include different or additional imaging modalities.

Despite its demonstrated advantages, ANR operates within certain limitations that are important to acknowledge. Firstly, the requirement for a paired CT-MR reference pair, which must be pre-aligned through affine registration, introduces a layer of uncertainty. This pre-alignment is crucial for the initial training phase but can potentially introduce errors if the registration step is not precise, affecting the model's performance. Moreover, obtaining these reference pairs necessitates that they be acquired in close succession, implying that both imaging devices must be available and accessible within a short time frame. This requirement can be challenging in clinical settings where the availability of both CT and MR machines is limited or scheduling does not permit back-to-back imaging sessions. To mitigate these limitations, potential solutions include leveraging synthetic data generation techniques to reduce the dependency on immediate access to both imaging modalities.

We present ANR, a deep learning methodology for multi-modal medical image reconstruction that leverages implicit neural representations with prior embedding of anatomical deformations. ANR provides on-treatment CT and MR images at the same time from only a single CT imaging device and 20 X-ray projections. Our findings across various experiments for 3D MR and CT image reconstruction have demonstrated that ANR can quickly produce high-quality CT and MR images from sparsely sampled X-ray measurement data, out-performing existing patient-specific baselines and reducing radiation exposure and image acquisition times significantly. Being patient-specific, ANR's framework offers several distinct advantages. First, it eliminates the need for training data from external subjects, thereby reducing dependencies on extensive datasets and the generalization demands on the model. Furthermore, its broad applicability across various body sites, imaging devices, and patient profiles, makes it a universally adaptable solution for medical imaging needs.

This technique is not limited to generation of joint CT and MRI images from sparse CT projections. It can also be used to generate joint CT and MRI images from sparse MRI data. To do this, instead of back-propagating the gradient through the Radon transform, we update the anatomy-adaptive layer weights by back-propagating the gradient of the MSE loss between measurements through the Fourier transform that maps between image and frequency domains in MR imaging.

The technique could also be adapted to generate other multi-modality images, such as dual-energy CT images, hybrid of different types of MRI images (T1, T2, low and high fields, etc.). To do this, we update the anatomy-adaptive layer using the modality for which we have obtained new measurements, back-propagating through the Radon transform for CT modalities (dual-energy), and through the Fourier transform if the measurements correspond to a MRI modality (T1, T2, etc.).

1. A method for medical imaging, the method comprising:
a) performing a single-modality scan of a subject using a single-modality imaging device to acquire sparse measurements, wherein the single-modality is either computed tomography (CT) or magnetic resonance imaging (MRI); and
b) simultaneously reconstructing both CT and MR image pairs from the sparse single-modality measurements using a multi-layer perceptron (MLP) neural network;
wherein initial weights of the MLP are learned from a pair of pre-treatment CT and MR images of the subject.

2. The method of claim 1,
wherein the MLP accepts pixel spatial coordinates as input and outputs deformation vectors that transform the pre-treatment CT and MR images to the reconstructed CT and MR image pairs.

3. The method of claim 1,
wherein simultaneously reconstructing the CT and MR image pairs comprises
a) updating weights of only an anatomy-adaptive layer of the MLP using the sparse single-modality measurements,
b) generating deformation vectors using the MLP, and
c) transforming the pre-treatment CT and MR images to the reconstructed CT and MR image pairs using the deformation vectors.

4. The method of claim 3,
wherein the anatomy-adaptive layer encodes information specific to an individual patient anatomy and can be updated to represent other patient anatomies.

5. The method of claim 3,
wherein updating weights of an anatomy-adaptive layer of the MLP comprises back-propagating a gradient of a loss through a forward Radon transform.
